(19) United States
(12) Patent Application Publication
(10) Pub. No.: US 2026/0200322 A1
(43) Pub. Date: Jul. 16, 2026

(54) VEHICLE AND STEERING UNIT

(71) Applicant: KAWASAKI MOTORS, LTD., Hyogo (JP)

(72) Inventors: Momoka HIRAOKA, Hyogo (JP); Mitsuru KOBAYASHI, Hyogo (JP)

(73) Assignee: KAWASAKI MOTORS, LTD., Hyogo (JP)

(21) Appl. No.: 19/443,421

(22) Filed: Jan. 8, 2026

(30) Foreign Application Priority Data
Jan. 10, 2025 (JP) 2025-004147

(51) Int. Cl. B60K 35/50; B60K 35/22; B60K 35/60

(52) U.S. Cl. CPC B60K 35/50; B60K 35/22; B60K 35/60; B60K 2360/61; B60K 2360/685; B60K 2360/77

(57) ABSTRACT

A vehicle includes a steering unit including a steering shaft, a steering wheel, and a steering column. The vehicle includes a display device mounted on the steering column, and a controller. The steering unit tilts the steering shaft in the up-down direction via the steering column. When a display region of the display device is viewed in an extending direction of the steering shaft, the controller causes at least one first image representing vehicle information to be displayed on an inner side of a rim in a vehicle width direction of the display region. The at least one first image includes an upper end region and a lower end region, and a central region positioned between the upper end region and the lower end region. In relation to the upper end region and the lower end region, the central region protrudes in a direction separating, in the vehicle width direction, from a central region of the display region above a hub.

### CROSS REFERENCE TO RELATED APPLICATIONS

The present application claims priority to Japanese Patent Application No. 2025-4147 filed on Jan. 10, 2025, the contents of which are fully incorporated herein by reference.

### TECHNICAL FIELD

The present disclosure relates to a vehicle and a steering unit.

### BACKGROUND OF THE INVENTION

In U.S. Pat. No. 9,644,969 B2, a vehicle is disclosed that includes a display device configured to display vehicle information.

### SUMMARY OF THE INVENTION

According to a first aspect of the present disclosure, a vehicle is provided that includes a steering unit, a display device, and a controller. The steering unit includes a steering shaft, a steering wheel, and a steering column. The steering wheel includes a ring-shaped rim, a hub on an inner side of the rim and fixed to the steering shaft, and a spoke connecting the rim and the hub. The steering column is configured to support the steering shaft to be rotatable about an axis of the steering shaft. The steering unit is configured to tilt the steering shaft, via the steering column, in the up-down direction with respect to a vehicle body. The display device includes a display region in which vehicle information representing a state of the vehicle is displayed. The display device is disposed facing a rear surface of the steering wheel. The display device is mounted on the steering column at a position spaced from a dash panel of the vehicle, and is tiltable integrally with the steering column. The controller is configured to output the vehicle information to the display device and cause the display device to display the vehicle information. When the display region is viewed in an extending direction of the steering shaft, the controller causes at least one first image representing the vehicle information to be displayed on the inner side of the rim in a vehicle width direction of the display region. The at least one first image includes an upper end region and a lower end region, and a central region positioned between the upper end region and the lower end region. The central region protrudes, in relation to the upper end region and the lower end region, in a direction separating, in the vehicle width direction, from a central region of the display region above the hub.

According to a second aspect of the present disclosure, a vehicle is provided that includes a steering unit and a display device. The steering unit includes a steering shaft, a steering wheel, and a steering column. The steering wheel includes a ring-shaped rim, a hub on an inner side of the rim and fixed to the steering shaft, and a spoke connecting the rim and the hub. The steering column is configured to support the steering shaft to be rotatable about an axis of the steering shaft. The steering unit is configured to tilt the steering shaft, via the steering column, in the up-down direction with respect to a vehicle body. The display device includes a display region in which vehicle information representing a state of the vehicle is displayed. The display device is disposed facing a rear surface of the steering wheel. The display device is attached to the steering column at a position spaced from a dash panel of the vehicle, and is tiltable integrally with the steering column. The steering wheel includes a switch unit on the spoke. The switch unit is provided at a position, of the spoke, in a direction spaced from the hub in the vehicle width direction. The switch unit is configured to receive a manual operation of a user. The switch unit includes a first switch, a second switch, and a central switch disposed between the first switch and the second switch. The first switch and the second switch are configured in a manner that a protrusion amount of the first switch and the second switch from a front surface of the spoke monotonically decreases toward the central switch. At adjacent portions adjacent to the central switch, the protrusion amount of the first switch and the protrusion amount of the second switch are smaller than a protrusion amount of the central switch.

According to a third aspect of the present disclosure, a steering unit is provided. The steering unit includes a steering shaft, a steering wheel, and a steering column. The steering wheel includes a ring-shaped rim, a hub on an inner side of the rim and fixed to the steering shaft, and a spoke connecting the rim and the hub. The steering column is configured to support the steering shaft to be rotatable about an axis of the steering shaft. The steering wheel includes a switch unit provided at a position, of the spoke, in a direction spaced from the hub in a vehicle width direction and configured to receive a manual operation of a user. The switch unit includes a first switch, a second switch, and a central switch disposed between the first switch and the second switch. The first switch and the second switch are configured in a manner that a protrusion amount of the first switch and the second switch from a front surface of the spoke monotonically decreases toward the central switch. At adjacent portions adjacent to the central switch, the protrusion amount of the first switch and the protrusion amount of the second switch are smaller than a protrusion amount of the central switch.

### BRIEF DESCRIPTION OF DRAWINGS

FIG. 1 is a schematic side view of a vehicle.

FIG. 2 is an enlarged view of a section S in FIG. 1, and is a schematic side view of a steering unit and a display device.

FIG. 3 is a top view of a steering wheel and the display device.

FIG. 4 is a view for describing a state of a steering shaft tilting, together with the display device, from a state shown in FIG. 2.

FIG. 5 is a view as seen in a direction D of the steering wheel and the display device.

FIG. 6 is a block diagram showing a configuration of the vehicle.

FIG. 7 is a view for describing a first image and a second image displayed in a display region.

FIG. 8 is a view showing a specific example of the first image and the second image displayed in the display region.

FIG. 9 is a cross-sectional view along a line IX-IX of a switch unit shown in FIG. 5.

### DETAILED DESCRIPTION OF THE INVENTION

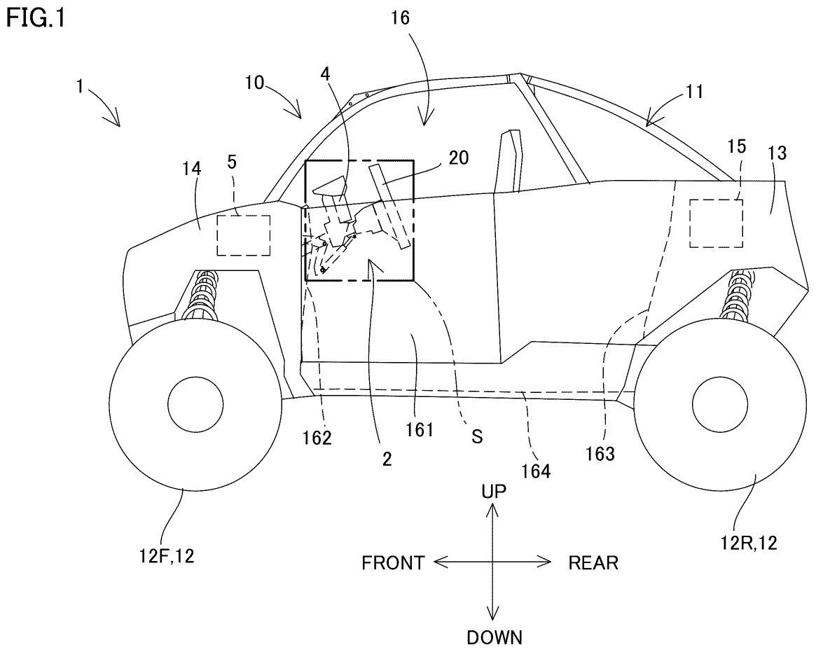

FIG. 1 is a schematic side view of a vehicle 1 according to an embodiment of the present disclosure. The vehicle 1 is a vehicle that travels off-road, not only mainly over grassy ground or gravel roads, or sandy ground, but also on unpaved mountain roads or forest roads, muddy ground, rocky areas, and the like. In FIG. 1 and the subsequent drawings, the front-rear direction, the up-down direction, and the left-right direction of the vehicle 1 are indicated as appropriate. Each of the directions is orthogonal to the other directions. The front-rear direction is also a vehicle length direction. In the front-rear direction, forward is a direction of advancement of the vehicle 1, and rearward is a reverse direction of the vehicle 1. The left-right direction is also a vehicle width direction. In the up-down direction, downward is a direction in which wheels of the vehicle are provided.

As shown in FIG. 1, the vehicle 1 includes a vehicle body 10 that includes a vehicle body frame 11, wheels 12 that support the vehicle body 10, an engine 15 that is a power source for operation of the vehicle 1, a steering unit 2, a display device 4, and a control unit 5. The wheels 12 include a pair of left and right front wheels 12F and a pair of left and right rear wheels 12R. In the present embodiment, the engine 15 is disposed at a rear section 13 of the vehicle body 10. The control unit 5 is disposed in a front section 14 of the vehicle body 10.

The vehicle body frame 11 is a frame structure made from a sectioned material. The vehicle body frame 11 functions as a framework of the vehicle body 10. The vehicle body frame 11 is configured to realize a rollover protective structure (ROPS).

A cabin 16, into which a passenger enters, is provided between the front wheels 12F and the rear wheels 12R of the vehicle body 10. The cabin 16 is surrounded by doors 161, a dash panel 162 that forms a partition between the cabin 16 and the front section 14, a rear panel 163 that forms a partition between the cabin 16 and the rear section 13, a floor panel 164, and the like. The cabin 16 may be further surrounded by windows, a roof, and the like.

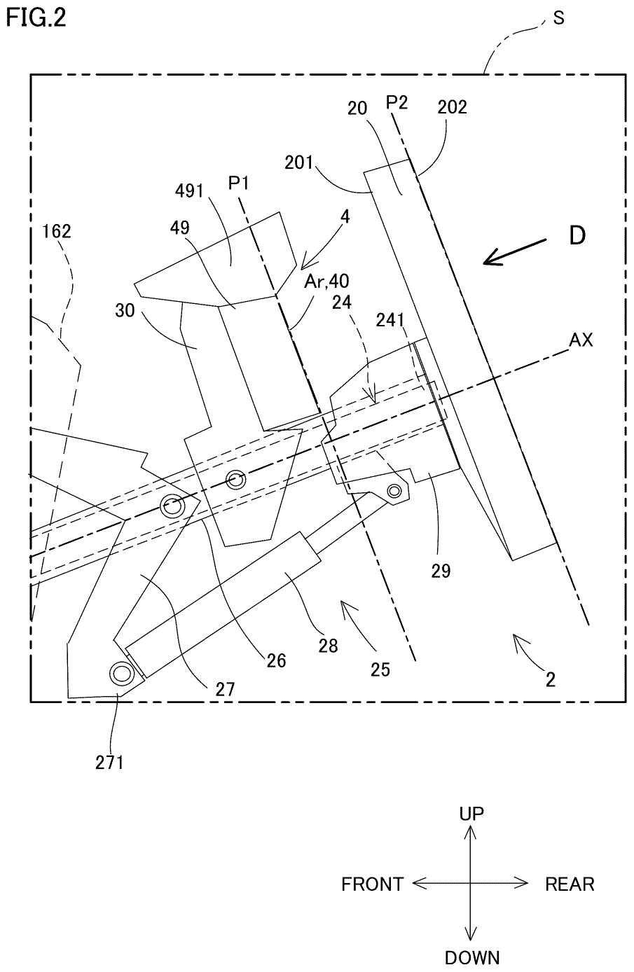

As shown in FIG. 2, the steering unit 2 includes a steering shaft 24, a steering wheel 20 attached to a rear end 241 of the steering shaft 24, and a steering column 25. The steering unit 2 is configured to impart a steering angle to a steered wheel of the wheels 12.

The steering shaft 24 is configured to rotate about an axis AX of the steering shaft 24 in accordance with rotation (revolution) of the steering wheel 20, and to transmit the rotation of the steering wheel 20 to the wheels 12 via a gear box or the like, for example. The steering shaft 24 penetrates the dash panel 162 from the front section 14 and protrudes into the cabin 16. The rear end 241, which is the protruding end of the steering shaft 24, includes a known engagement mechanism with which the steering wheel 20 is detachably engaged.

The steering column 25 supports the steering shaft 24 so as to be able to rotate about the axis AX. The steering column 25 includes a tilt mechanism that tilts the steering shaft 24 in the up-down direction with respect to the vehicle body 10. In the present embodiment, the steering column 25 includes a cylindrical portion 26, a first bracket 27, and a joint portion 28. The steering shaft 24 is disposed inside the cylindrical portion 26 so as to be able to rotate. The first bracket 27 is rotatably connected to the cylindrical portion 26. The joint portion 28 includes a shaft that connects a lower end portion 271 of the first bracket 27 to a portion in the vicinity of the rear end 241 of the steering shaft 24 in the cylindrical portion 26. The steering column 25 tilts the steering shaft 24 in the up-down direction with respect to the vehicle body 10 as a result of each of portions of these members moving in conjunction with each other. The steering column 25 may include a telescopic mechanism configured to adjust the steering shaft 24 in the front-rear direction.

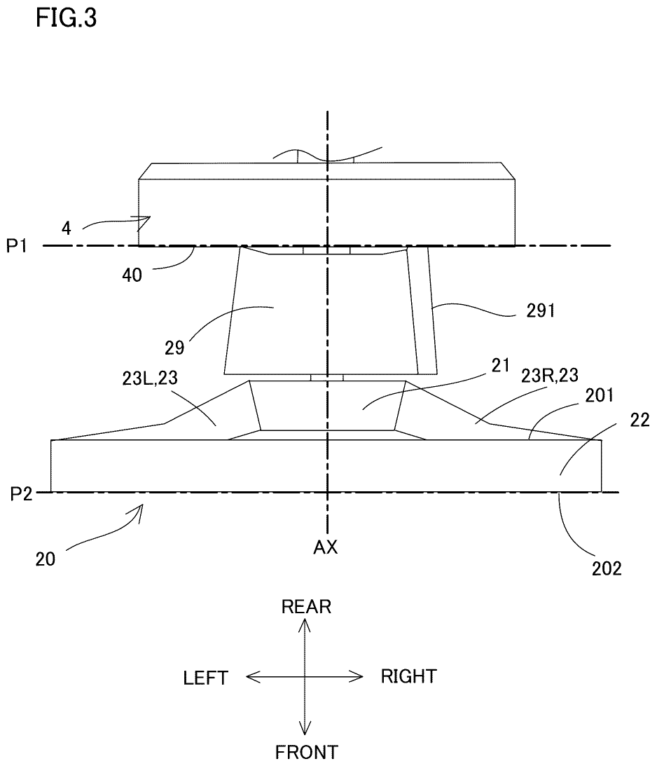

The steering column 25 further includes a column cover 29. The column cover 29 covers the rear end 241 of the steering shaft 24 via the cylindrical portion 26. As shown in FIG. 3, the column cover 29 includes a protrusion 291 that protrudes in the vehicle width direction. In the present embodiment, the protrusion 291 protrudes to the right when seen from above the vehicle. A wiring line that electrically connects a switch unit 9 provided on the steering wheel 20 and the control unit 5 is disposed inside the protrusion 291. The switch unit 9 will be described in detail later.

The display device 4 notifies a user of various vehicle information indicating a drive state of the vehicle 1. The various vehicle information includes, for example, a speed, an engine rotation speed, a travel distance, a boost pressure, an oil temperature, a remaining fuel amount, a drive wheel, a suspension mode, a gear mode, various warnings, and the like.

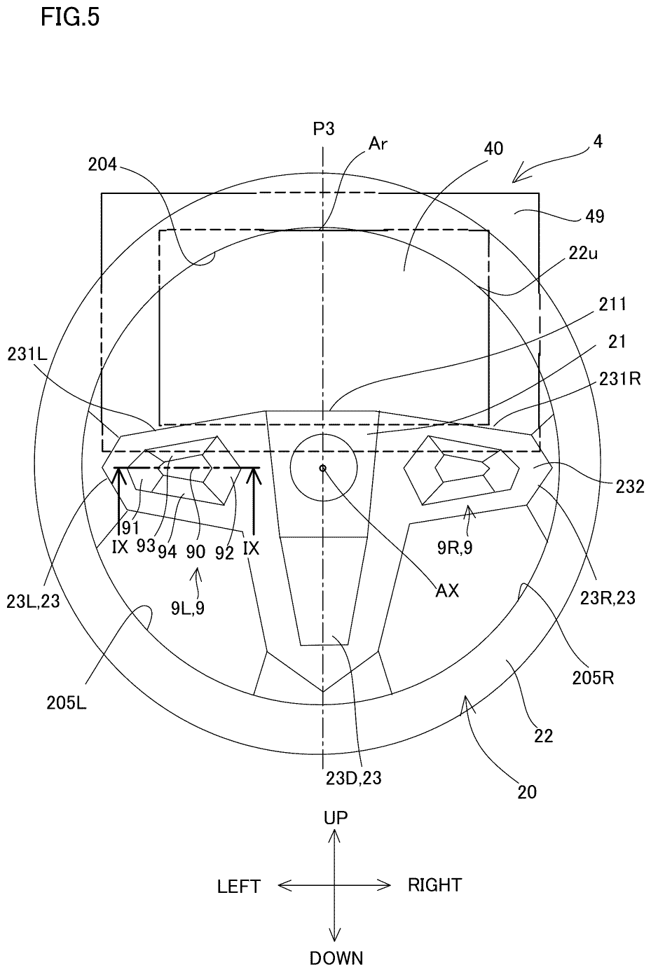

As shown in FIG. 2, the display device 4 includes a display 40, and a frame 49 that supports the display 40. The display 40 includes a rectangular display region Ar (refer to FIG. 5) having long sides in the vehicle width direction. The display 40 may be configured by a liquid crystal panel or organic EL. The display device 4 displays the vehicle information in the display region Ar under control of a display controller 54. The display controller 54 will be described later. As shown in FIG. 2, a cover 491 (visor) is provided at an upper portion of the frame 49, to improve visibility of the display region Ar for the user. The cover 491 is omitted as appropriate in other drawings.

As shown in FIG. 1 and FIG. 2, the display device 4 is mounted on the steering column 25 at a position spaced in a vehicle cabin direction from the dash panel 162. As shown in FIG. 2, the display 40 (the display region Ar) is fixed to the steering column 25 via the frame 49, facing an upper section of a rear surface 201 in the steering wheel 20.

In the present embodiment, a second bracket 30 that holds the display device 4 is fixed to the cylindrical portion 26 of the steering column 25. The second bracket 30 is fixed to the cylindrical portion 26, at a position between the first bracket 27 and the column cover 29 in the axis AX direction, and spaced from the dash panel 162. The second bracket 30 protrudes upward from the cylindrical portion 26 and holds the display device 4. A virtual plane P1 including the display 40 (the display region Ar) and a virtual plane P2 including a front surface 202 of the steering wheel 20 are illustrated in FIG. 2. The plane P1 is orthogonal to the axis AX of the steering shaft 24. Further, the plane P1 is parallel to the plane P2.

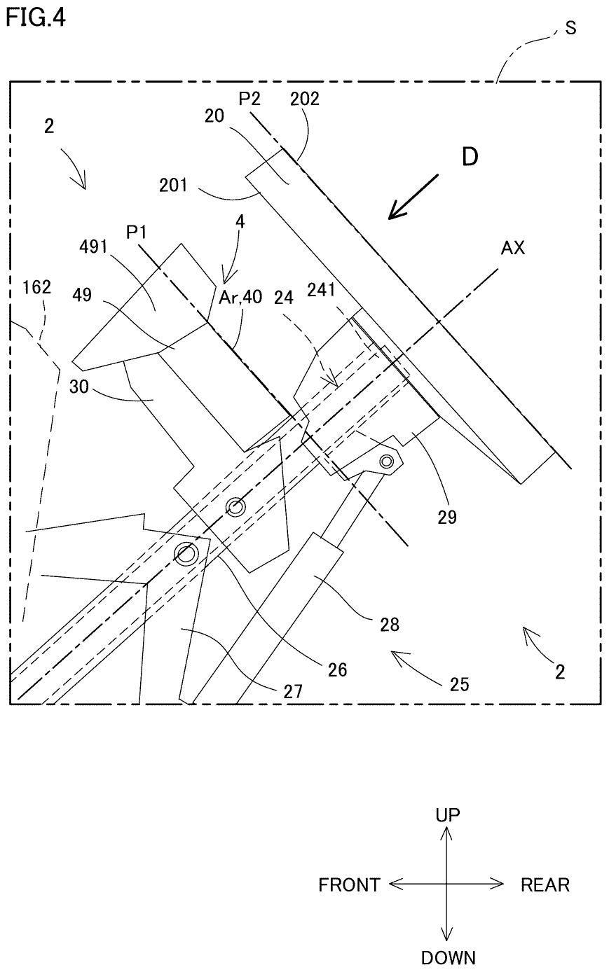

FIG. 4 illustrates the steering unit 2 when the steering shaft 24 has been tilted upward from the state illustrated in FIG. 2. As described above, the display device 4 is fixed to the steering column 25. Thus, when the steering shaft 24 can be tilted upward, the display device 4 is tilted upward integrally with the steering shaft 24 via the steering column 25. As a result, a positional relationship of the display device 4 in relation to the steering wheel 20 is maintained regardless of a tilt angle of the steering shaft 24. In the present embodiment, the virtual plane P1 is orthogonal to the axis AX regardless of the tilt angle of the steering shaft 24. Further, the virtual plane P1 is parallel to the virtual plane P2 regardless of the tilt angle of the steering shaft 24. Note that there is no interference between the display device 4 and the dash panel 162 even when the steering shaft 24 is tilted.

FIG. 5 is a view of the steering wheel 20 and the display device 4 as seen from a direction D (refer to FIG. 2 and FIG. 4) parallel to the axis AX. The steering wheel 20 includes a ring-shaped rim 22, a hub 21 provided on the inner side of the rim 22 and connected to the rear end 241 of the steering shaft 24, and a spoke 23 that connects the rim 22 and the hub 21. The rim 22 is ring-shaped, and may also be referred to as an annular rim. In the present embodiment, the spoke 23 includes a left spoke 23L that protrudes leftward from the hub 21, a right spoke 23R that protrudes rightward from the hub 21, and a lower spoke 23D that protrudes downward from the hub 21 in an initial state in which the steering angle is zero. The switch unit 9 is further provided on the spoke 23 of the steering wheel 20. The switch unit 9 will be described later.

The steering wheel 20 includes openings 204, 205L, and 205R defined by the rim 22, the hub 21, and the spoke 23. The opening 204 is defined by an upper end 231L of the left spoke 23L, an upper end 231R of the right spoke 23R, an upper end 211 of the hub 21, and an inner peripheral portion 22u in an upper section of the rim 22. The opening 204 has a substantially semicircular shape. The opening 205L is defined mainly by the left spoke 23L, the lower spoke 23D, and an inner peripheral portion in a lower left section of the rim 22. The opening 205R is defined mainly by the right spoke 23R, the lower spoke 23D, and an inner peripheral portion in a lower right section of the rim 22. In the initial state in which the steering angle is zero, the opening 204 faces the display region Ar.

Since the steering shaft 24 can be tilted in the up-down direction with respect to the vehicle body 10 in accordance with a physique and posture of the user, a positional relationship between the axis AX of the steering shaft 24 and the head of the user does not significantly change even when the steering shaft 24 is tilted. As described above, the display device 4 tilts in the up-down direction integrally with the steering shaft 24, and a positional relationship between the user and the display 40 is also substantially maintained. Thus, regardless of the tilt angle of the steering shaft 24, the user views the display 40 (the display region Ar) via the opening 204, in the direction D parallel to the axis AX of the steering shaft 24. Here, when the display region Ar is viewed in the direction D via the opening 204, the steering wheel 20 partially overlaps the display region Ar. In the example shown in FIG. 5, the rim 22 overlaps an upper left corner portion and an upper right corner portion of the display region Ar, and the spoke 23 and the hub 21 overlap the lower end of the display region Ar.

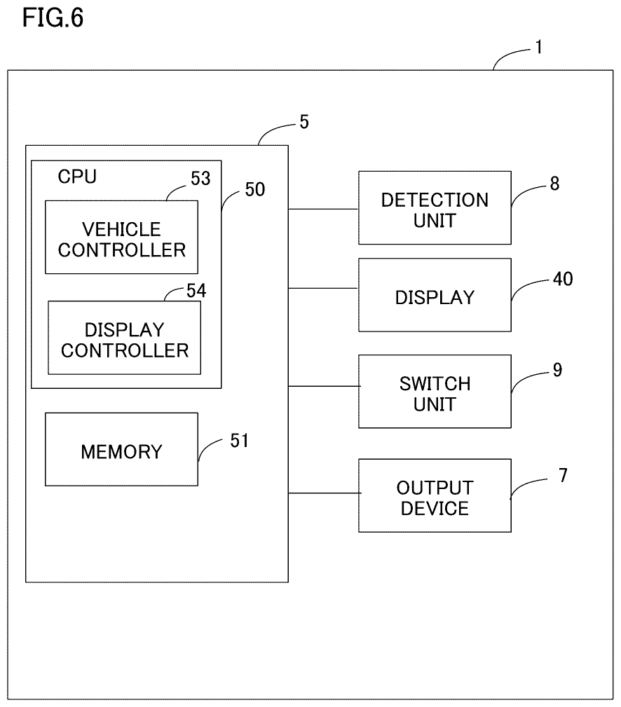

In the present embodiment, in the vehicle 1 having this type of relationship between the steering wheel 20 and the display region Ar, under the control of the display controller 54, it is possible to improve the visibility of the vehicle information displayed in the display region Ar for the user. Hereinafter, with reference to FIG. 6 to FIG. 8, a format will be described in which the control unit 5 including the display controller 54 displays the vehicle information in the display region Ar.

As shown in FIG. 6, the control unit 5 is connected to a detection unit 8, the switch unit 9, the display 40, and an output device 7, via an interface that is not shown in the drawings.

The detection unit 8 includes various sensors that detect the state of the vehicle 1. The various sensors include, for example, a vehicle speed sensor, an acceleration sensor, a position/posture sensor using GPS or GNSS, an engine rotation speed sensor, a gear position sensor, a throttle opening sensor, an intake air temperature sensor, an oil temperature sensor, an intake air pressure sensor, an accelerator operation amount sensor, a brake operation amount sensor, and a gear shift operation sensor. The detection unit 8 outputs a detection result to the control unit 5, during a period in which power is supplied from a battery installed in the vehicle 1.

The output device 7 is a device that performs various outputs by operating switches provided in the switch unit 9 or in the dash panel 162 of the vehicle 1. The output device 7 includes a speaker, or an air conditioner for example. The output device 7 may include the display device 4.

The control unit 5 is configured as an electronic control unit (ECU) that includes a CPU 50, a memory 51, and the interface (not shown in the drawings). The CPU 50 functions as a vehicle controller 53 and the display controller 54, by reading and executing a program stored in the memory 51. The functions of the CPU 50 may be realized by a processing circuit or a processor.

The vehicle controller 53 acquires the detection result of the detection unit 8, and generates the various vehicle information. The display controller 54 generates an image corresponding to the vehicle information generated by the vehicle controller 53, in accordance with a display mode stored in the memory 51, and outputs the image to the display device 4. In this way, the image representing the various vehicle information is displayed in the display region Ar of the display 40.

The display mode relates to the various vehicle information, and includes a relationship between a position (region) of the display region Ar in which each of the pieces of vehicle information is displayed, and a display format of the vehicle information displayed in the region. The display format includes a display method representing the vehicle information, such as an analog gauge and a bar display, or a digital numerical display and the like, a shape, color, and size of the image represented by the method, or a background color of the whole of the display region Ar, or a background image and the like.

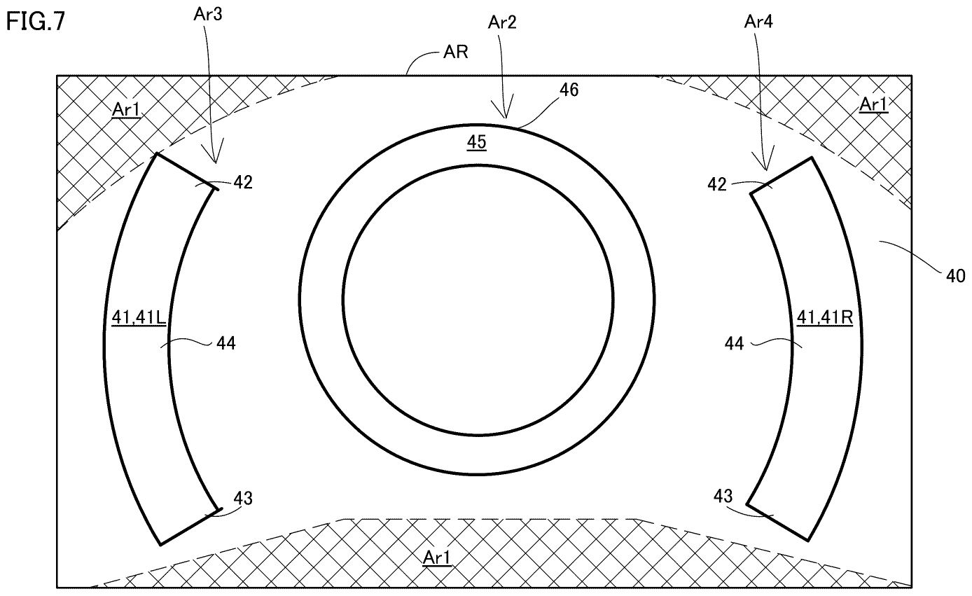

In FIG. 7, of the display region Ar of the display 40, positions and shapes of overlapping regions Ar1, a central region Ar2, regions Ar3 and Ar4, a first image 41 and a second image 45 as the vehicle information are illustrated. The overlapping regions Ar1 are regions of the display region Ar overlapping the steering wheel 20, when the display 40 is seen via the opening 204 in the direction D from the front surface 202 of the steering wheel 20. The overlapping regions Ar1 are regions at which visibility is comparatively difficult when the user of the vehicle 1 views the display 40. The central region Ar2 is a region substantially in the center of the display region Ar in the vehicle width direction, and is positioned above the hub 21 when the display 40 is viewed via the opening 204 from the direction D. The regions Ar3 and Ar4 are positioned to the left and the right of the central region Ar2, respectively. The regions Ar3 and Ar4 are also regions inside the rim 22 in the vehicle width direction.

The display controller 54 displays the first image 41 representing the vehicle information in at least one of the regions Ar3 and Ar4. The first image 41 includes an upper end region 42 and a lower end region 43, and a central region 44 positioned between the upper end region 42 and the lower end region 43 and protruding in a direction separating from the central region Ar2 in the vehicle width direction. In the up-down direction, the upper end region 42 defines one end in an extending direction of the first image 41, and the lower end region 43 defines the other end in the extending direction of the first image 41. In the example shown in FIG. 7, the upper end region 42 and the lower end region 43 do not substantially overlap the overlapping regions Ar1. In FIG. 7, first images 41L and 41R are displayed in the regions Ar3 and Ar4. The first image 41L is displayed in the leftward direction in relation to the central region Ar2, and the first image 41R is displayed in the rightward direction in relation to the central region Ar2.

The first images 41L and 41R shown in FIG. 7 have a circular arc shape. It is sufficient that the first image 41 have the substantially circular arc shape in which the central region 44 protrudes in the direction separating from the central region Ar2 in the vehicle width direction in relation to the upper end region 42 and the lower end region 43. The substantially circular arc shape includes an angle bracket shape, for example.

The display controller 54 further displays the second image 45 in the central region Ar2 on the inner side of the first images 41L and 41R in the vehicle width direction. In FIG. 7, the second image 45 has a circular shape, but the second image 45 may have a substantially circular arc shape. An upper end 46 of the second image 45 is positioned higher than the upper end regions 42 of the first images 41L and 41R.

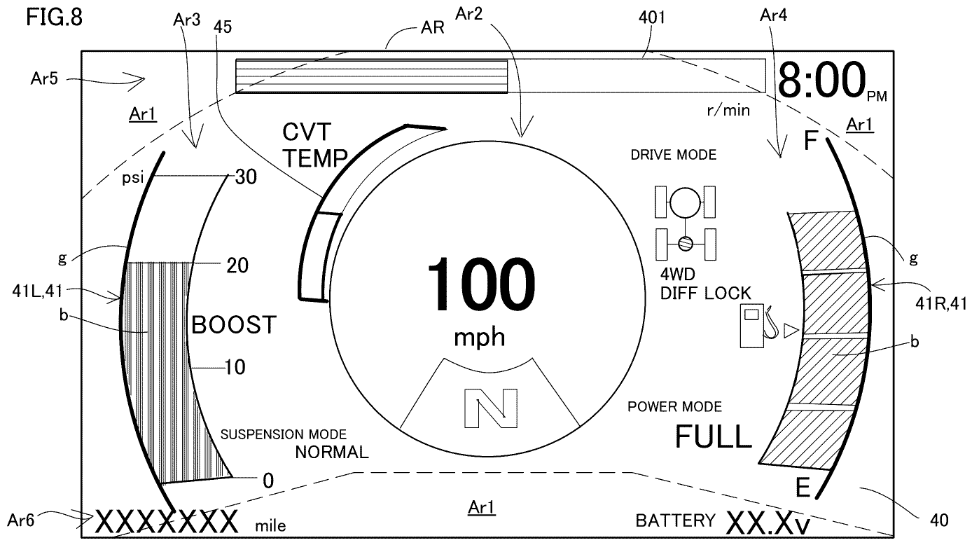

In FIG. 8, the first images 41L and 41R and the second image 45 displayed in the display region Ar are illustrated in detail. The first image 41L displayed in the region Ar3 is a type of gauge image representing a boost pressure. The gauge image includes a gauge g having a substantially circular arc shape corresponding to a numerical range that can be obtained in the vehicle information, and a bar b representing a current value as a band along the gauge. The first image 41R displayed in the region Ar4 is a gauge image representing the remaining fuel amount. The second image 45 is a gauge image representing the oil temperature of a continuously variable transmission (CVT).

A plurality of pieces of vehicle information are further displayed in the display region Ar. For example, in the example shown in FIG. 8, the vehicle speed and the gear mode are displayed in the central region Ar2, inside the second image 45. Further, an image 401 representing the rotation speed of the engine 15 is displayed in an upper end region Ar5 of the display region Ar. A total mileage and a remaining battery amount are displayed in a lower end region Ar6 of the display region Ar. At least a part of each of the upper end region Ar5 and the lower end region Ar6 overlaps the overlapping region Ar1. The user can visually check the vehicle information (the images representing the vehicle information) displayed in the regions Ar5 and Ar6 by viewing the display 40 via the opening 204 from a direction intersecting the direction D.

In the vehicle 1 as described above, the display device 4 is fixed to the steering column 25 so as to be tilted integrally with the steering shaft 24. Thus, even when the user tilts the steering shaft 24 to suit their own physique, the positional relationship between the display 40 and the steering wheel 20 is maintained. In this way, the positional relationship of the display 40 in relation to the user is maintained. In the vehicle 1 in which the positional relationship between the steering unit 2 and the display device 4 is such as described above, the first image 41, which includes the upper end region 42 and the lower end region 43, and the central region 44 that protrudes in the direction separating from the central region Ar2 in the vehicle width direction, is displayed inside the rim 22 in the vehicle width direction of the display region Ar. Thus, a major part or all of the first image 41 is displayed at a position that is not likely to be covered by the steering wheel 20, regardless of the tilt angle of the steering shaft 24. Thus, the visibility of the first image 41 for the user can be improved. Further, it is possible to suppress an increase in a movement amount of a line of sight of the user, to visually check the first image 41, which moves due to the rotation of the steering wheel 20.

Although a comparatively long band-shaped region is necessary in order to represent the vehicle information using the gauge image including the gauge g and the bar b, when the band-shaped region is displayed on the display 40, the band-shaped region is likely to overlap the steering wheel 20. According to the present embodiment, the gauge image is realized by the first image 41 in which the central region 44 protrudes in the vehicle width direction in relation to the upper end region 42 and the lower end region 43. Thus, while securing the length from one end to the other end in the extending direction of the gauge image, the upper end region 42 and the lower end region 43 can be disposed at positions less likely to overlap the steering wheel 20. As a result, the visibility of the vehicle information for the user can be further improved.

In the present embodiment, the second image 45 is further displayed on the inner side of the first images 41L and 41R in the vehicle width direction. Since the first images 41L and 41R have the substantially circular arc shape, and the second image 45 has the circular or substantially circular arc shape, the design of the vehicle information as a whole displayed in the display region Ar is improved. Further, it is possible to suppress an increase in a movement amount of the line of sight of the user, to visually check the second image 45, which moves due to the rotation of the steering wheel 20.

The second image 45 is disposed to the inner side in the vehicle width direction in relation to the first images 41L and 41R, in other words, is positioned in the vicinity of the central region Ar2. The upper end 46 of the second image 45 is positioned higher than the upper end region 42 of the first image 41. The vicinity of the central region Ar2 in which the second image 45 is positioned is not likely to be covered by the rim 22 of the steering wheel 20. Thus, it is possible to improve the visibility for the user while effectively utilizing the display region Ar.

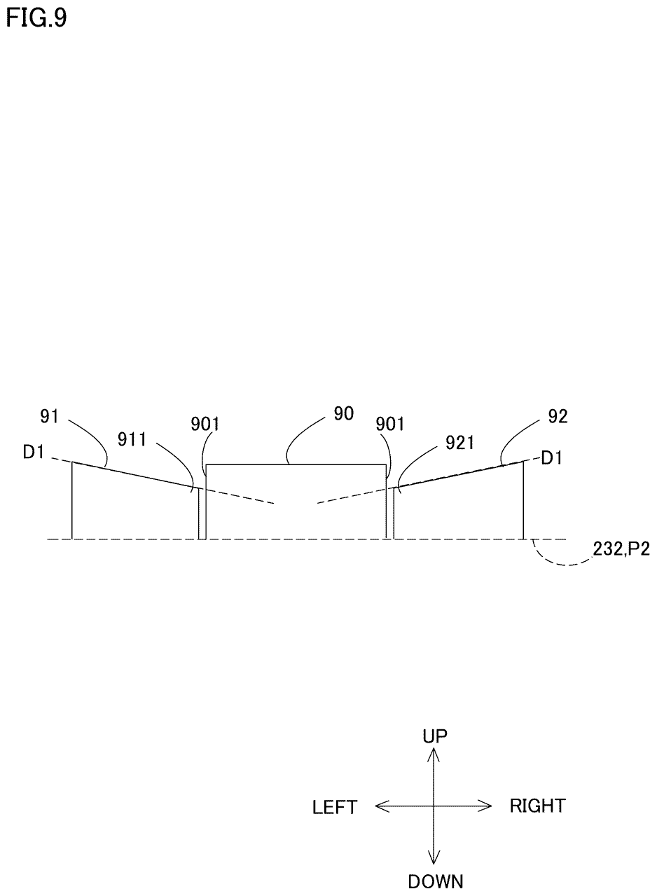

Hereinafter, the switch unit 9 provided on the steering wheel 20 will be described mainly with reference to FIG. 5 and FIG. 9. In the present embodiment, the switch unit 9 is fixed to the steering wheel 20 from the rear surface 201 (refer to FIG. 2) using a bolt. As shown in FIG. 5, the switch unit 9 includes a switch unit 9L provided on the left spoke 23L and a right switch unit 9R provided on the right spoke 23R. The shape of the switch unit 9R is symmetrical to the shape of the switch unit 9L provided on the left spoke 23L, with respect to a plane P3 that includes the axis AX and is orthogonal to the plane P2. Hereinafter, the shape of the switch unit 9 will be described taking the switch unit 9L provided on the left spoke 23L as an example.

The switch unit 9L includes a central switch 90, a switch 91 disposed to the left of the central switch 90, a switch 92 disposed to the right of the central switch 90, a switch 93 disposed above the central switch 90, and a switch 94 disposed below the central switch 90. The switches 91, 92, 93, and 94 are peripheral switches surrounding the central switch 90. Each of the switches 91, 92, 93, and 94 is adjacent to the central switch 90. These switches 90, 91, 92, 93, and 94 are configured to be able to adjust an output of the output device 7 (refer to FIG. 6) provided in the vehicle 1. The switches 90, 91, 92, 93, and 94 receive a manual operation by the user and output the operation to the control unit 5. Based on signals received from the switches 90, 91, 92, 93, and 94, the control unit 5 causes the output device 7 to perform the output corresponding to the switch, changes an output mode, and the like.

FIG. 9 illustrates a cross-sectional view of the switch unit 9L along a line IX-IX. The cross-section along the line IX-IX is orthogonal to the virtual plane P2. The virtual plane P2 can be taken as being roughly a front surface 232 of the spoke 23. As shown in FIG. 9, a protrusion amount of the switch 91 from the front surface 232 of the left spoke 23L monotonically decreases toward the central switch 90. A protrusion amount of the switch 92 from the front surface 232 of the left spoke 23L monotonically decreases toward the central switch 90. Monotonically decreasing refers to monotonically decreasing in a broad sense. Monotonically decreasing in the broad sense can also be referred to as not monotonically increasing. An adjacent portion 911 adjacent to the central switch 90 in the switch 91 and an adjacent portion 921 adjacent to the central switch 90 in the switch 92 are further illustrated in FIG. 9. Protrusion amounts of the adjacent portions 911 and 921 are less than a protrusion amounts of the central switch 90. In other words, in the vicinity of borders between the switches 91 and 92 and the central switch 90, the central switch 90 protrudes more than the switches 91 and 92. Extending directions D1 of front surfaces of the switches 91 and 92 intersect side walls 901 of the central switch 90. Note that relationships of the shapes of the central switch 90, and the switches 93 and 94 adjacent to the central switch 90 in the up-down direction are the same as the relationships of the shapes of the central switch 90, and the switches 91 and 92, and a description thereof is thus omitted here.

As described above, the switch unit 9 is configured overall such that the protrusion amounts of the switches 91, 92, 93, and 94 monotonically decrease toward the central switch 90. The extending directions D1 of the front surfaces of the peripheral switches 91, 92, 93, and 94 intersect the side walls 901 of the central switch 90. Thus, a finger of the user that is moved toward the central switch 90 from the switches 91 and 92 hits the side wall 901 of the central switch 90. In this way, since the protrusion amounts in the switch unit 9 decrease toward the central switch 90, and a stepped shape is formed such that the central switch 90 protrudes, the user can ascertain the position of each of the switches, using the position of each of the switches with respect to the central switch 90 and using the stepped shape. Specifically, the user that manually operates the switch unit 9 can easily recognize, using their finger, the boundary between the switch 91 and the central switch 90 without visually checking the switch unit 9. Similarly, the boundary between each of the switches 92, 93, and 94 and the central switch 90 can be easily recognized. Thus, according to the switch unit 9 according to the present embodiment, erroneous operation of each of the switches 90, 91, 92, 93, and 94 by the user can be suppressed.

Further, since the user can operate each of the switches without moving their line of sight to the switch unit 9, a situation is suppressed in which the vehicle information displayed on the display device 4 is overlooked when each of the switches 90, 91, 92, 93, and 94 is operated. As a result, the switch unit 9 contributes to improving the visibility of the vehicle information.

As described above, the present disclosure relates to the configuration in the vicinity of the steering wheel of the vehicle, and contributes to improving at least one of visibility of information and operability.

A correspondence between each of structural elements (features) of the above-described embodiment and each of structural elements (features) of the present disclosure or the invention is as described below. Note that each of the structural elements of the embodiment is merely an example, and is not intended to limit each of the structural elements of the present disclosure or the invention.

The vehicle 1 is an example of a “vehicle”. The steering shaft 24, the steering column 25, and the steering wheel 20 are an example of a “steering unit”. The rear end 241 of the steering shaft 24 is an example of an “attachment end”.

The cylindrical portion 26, the first bracket 27, the joint portion 28, the column cover 29, the second bracket 30, and the steering column 25 are an example of a “steering column”.

The display region Ar, the display 40, and the display device 4 are an example of a “display device”.

The central region Ar2 is an example of a “central region”.

The CPU 50, the control unit 5 and the display controller 54 are an example of a

### “controller”.

The upper end 211, the upper end 231L, and the upper end 231R are an example of “upper ends of a hub and a spoke”.

The axis AX and the direction D are an example of an “extending direction of a steering shaft”.

The opening 204 is an example of an “opening”.

The first images 41, 41L, and 41R are an example of “at least one first image”.

The upper end region 42, the lower end region 43, and the central region 44 are, respectively, an example of an “upper end region,” a “lower end region”, and a “central region” in the first image.

The second image 45 is an example of “at least one second image”.

The first images 41L and 41R, the gauge g, and the bar b are an example of a “gauge image”.

The leftward direction and the rightward direction are an example of a “first direction” and a “second direction”.

The upper end 46 and the upper end region 42 are, respectively, an example of “an upper end of the second image” and “an upper end of the first image”.

The switch units 9, 9L, and 9R are an example of a “switch unit”. The central switch 90 is an example of a “central switch”. The switch 91 and the switch 92, and the switch 93 and the switch 94 are examples of a “first switch and a second switch”.

The adjacent portions 911 and 921 are examples of an “adjacent portion”.

The virtual plane P1 is an example of a “virtual plane”.

The detection unit 8 is an example of a “detection unit”.

The vehicle according to the present disclosure is not limited to the above-described embodiment. For example, changes exemplified below in a non-limiting manner are possible.

In the above-described embodiment, a plurality of display modes may be stored in the memory 51, and the display controller 54 may display the vehicle information on the display 40 using a selected display mode. The display mode may be selectable by the user operating each of the switches on the switch unit 9 provided on the steering wheel 20, or operating another input device. Note that a format including the positions and shapes of the first image and the second image displayed on the display 40 by the display controller 54 may also be any one of a display mode. According to this aspect, it is possible to realize display of the vehicle information in accordance with a preference of the user.

The first image 41L and the first image 41R need not necessarily have the symmetrical shape in the vehicle width direction. Further, the second image 45 may be displayed in a plurality of circular arc shapes in the central region Ar2.

The display controller 54 may dispose at least some of the plurality of pieces of vehicle information in a circular arc shape between the first image and the second image. According to this aspect, the design of the vehicle information as a whole displayed in the display region Ar can be improved.

In the above-described embodiment, the vehicle 1 is given as the example of the vehicle, but the display format of the vehicle information including the first image and the second image displayed on the display 40 by the display controller 54 is not limited to the vehicle 1, and can be applied to another vehicle in which the steering shaft 24 and the display device 4 are tilted integrally with each other.

The steering shaft 24 may be configured such that the steering wheel 20 is detachably attached (fixed) thereto, and the steering wheel 20 need not necessarily have the shape of the above-described embodiment. Further, the steering wheel 20 need not necessarily include the switch unit 9. Note that when the switch unit 9 is provided on the steering wheel 20, a number of the switches included in the switch unit 9 may be changed as appropriate.

At least some of the functions of the display controller 54 may be included in the display device 4.

As a whole, it is sufficient that the switch unit 9 is configured such that the protrusion amounts monotonically decrease from the switch 91, the switch 92, the switch 93, and the switch 94 toward the central switch 90. The switch unit 9 may be applied to a structure not including the steering unit 2 and the display device 4. For example, the switch unit 9 may be provided in the dash panel 162 of the vehicle 1, or may be applied to a vehicle or operation equipment other than the vehicle 1. In this aspect also, the effect is achieved in which the erroneous operation of each of the switches 90, 91, 92, 93, and 94 can be suppressed.

The present disclosure can be realized in various aspects other than those described above. For example, the present disclosure can be realized by an aspect such as a computer program for realizing the functions of the display controller, a non-transitory storage medium storing the computer program, and the like. For example, the computer program may be a program that causes a computer to perform communication and acquire, from a vehicle, vehicle information indicating a state of the vehicle, to output the vehicle information to a display based on a predetermined mode stored in a memory, and to display a first image inside a rim, in a vehicle width direction of a display region of the display. The first image may include an upper end region and a lower end region, and a central region that is positioned between the upper end region and the lower end region and protrudes, in relation to the upper end region and the lower end region, in a direction separating, in the vehicle width direction, from a central region of the display region above a hub.

What is claimed is:

1. A vehicle comprising:
a steering unit, the steering unit including
a steering shaft,
a steering wheel including a ring-shaped rim, a hub on an inner side of the rim and fixed to the steering shaft, and a spoke connecting the rim and the hub, and
a steering column supporting the steering shaft to be rotatable about an axis of the steering shaft,
the steering column supporting the steering shaft so that the steering shaft is tiltable in the up-down direction with respect to a vehicle body;
a display device including a display region in which vehicle information representing a state of the vehicle is displayed, the display device facing a rear surface of the steering wheel, mounted on the steering column at a position spaced from a dash panel of the vehicle, and being tiltable integrally with the steering column; and
a controller that outputs the vehicle information to the display device and causes the display device to display the vehicle information, wherein
when the display region is viewed in an extending direction of the steering shaft, the controller causes at least one first image representing the vehicle information to be displayed on the inner side of the rim in a vehicle width direction of the display region, and
the at least one first image includes an upper end region and a lower end region, and a central region positioned between the upper end region and the lower end region, the central region protruding, in relation to the upper end region and the lower end region, in a direction separating, in the vehicle width direction, from a central region of the display region above the hub.

2. The vehicle according to claim 1, wherein
the steering wheel includes an opening, the opening being positioned above the hub in an initial state of a steering angle of the vehicle being zero, and being defined by upper ends of the hub and the spoke, and a part of the rim, and
when the display region is viewed via the opening in the extending direction of the steering shaft, the controller causes the at least one first image to be displayed on the inner side of the rim in the vehicle width direction of the display region.

3. The vehicle according to claim 1, wherein
the at least one first image includes a gauge image.

4. The vehicle according to claim 1, wherein
the at least one first image is a pair of the first images displayed, in relation to the central region, in a first direction in the vehicle width direction and in a second direction opposite to the first direction.

5. The vehicle according to claim 1, wherein
the controller causes at least one second image with a circular shape or a substantially circular arc shape to be displayed in the central region.

6. The vehicle according to claim 5, wherein
an upper end of the at least one second image is positioned higher than an upper end of the first image in the up-down direction.

7. The vehicle according to claim 1, wherein
the steering wheel includes a switch unit at a position of the spoke, in a direction spaced from the hub in the vehicle width direction and configured to receive a manual operation of a user,
the switch unit includes a first switch, a second switch, and a central switch disposed between the first switch and the second switch,
the first switch and the second switch are arranged such that a protrusion amount of the first switch and the second switch from a front surface of the spoke monotonically decreases toward the central switch, and
at adjacent portions adjacent to the central switch, the protrusion amount of the first switch and the protrusion amount of the second switch are smaller than a protrusion amount of the central switch.

8. The vehicle according to claim 1, wherein
the display device is fixed to the steering column in a manner that a virtual plane including the display region is orthogonal to the axis of the steering shaft.

9. The vehicle according to claim 1, further comprising:
a detection unit configured to detect the state of the vehicle, wherein
the controller generates the vehicle information using a detection result of the detection unit, and causes the first image to be output to the display device based on the generated vehicle information.

10. The vehicle according to claim 1, wherein
the steering shaft includes an attachment end configured for the hub of the steering wheel to be detachably fixed thereto.

11. A vehicle comprising:
a steering unit, the steering unit including
a steering shaft,
a steering wheel including a ring-shaped rim, a hub on an inner side of the rim and fixed to the steering shaft, and a spoke connecting the rim and the hub, and
a steering column supporting the steering shaft to be rotatable about an axis of the steering shaft, wherein
the steering wheel includes a switch unit at a position of the spoke in a direction spaced from the hub in a vehicle width direction and configured to receive a manual operation of a user,
the switch unit includes a first switch, a second switch, and a central switch between the first switch and the second switch,
the first switch and the second switch are arranged such that a protrusion amount of the first switch and the second switch from a front surface of the spoke monotonically decreases toward the central switch, and
at adjacent portions adjacent to the central switch, the protrusion amount of the first switch and the protrusion amount of the second switch are smaller than a protrusion amount of the central switch.

12. The vehicle according to claim 11, wherein
the steering unit allows the steering shaft to tilt, via the steering column, in the up-down direction with respect to a vehicle body.

13. The vehicle according to claim 12, comprising:
a display device including a display region in which vehicle information representing a state of the vehicle is displayed,
the display device facing a rear surface of the steering wheel, mounted on the steering column at a position spaced from a dash panel of the vehicle, and being tiltable integrally with the steering column.

14. A steering unit comprising:
a steering shaft;
a steering wheel including a ring-shaped rim, a hub on an inner side of the rim and fixed to the steering shaft, and a spoke connecting the rim and the hub; and
a steering column supporting the steering shaft to be rotatable about an axis of the steering shaft, wherein
the steering wheel includes a switch unit at a position of the spoke in a direction spaced from the hub in a vehicle width direction and configured to receive a manual operation of a user,
the switch unit includes a first switch, a second switch, and a central switch disposed between the first switch and the second switch,
the first switch and the second switch are arranged such that a protrusion amount of the first switch and the second switch from a front surface of the spoke monotonically decreases toward the central switch, and
at adjacent portions adjacent to the central switch, the protrusion amount of the first switch and the protrusion amount of the second switch are smaller than a protrusion amount of the central switch.
